(19) United States
(12) Patent Application Publication
(10) Pub. No.: US 2010/0102738 A1
(43) Pub. Date: Apr. 29, 2010

(54) CIRCUIT ARRANGEMENT FOR OPERATING A VACUUM GAS DISCHARGE LAMP

(75) Inventors: Olaf Busse, Muenchen (DE); Bernhard Reiter, Muenchen (DE)

Correspondence Address: Viering, Jentschura & Partner - OSR, 3770 Highland Ave., Suite 203, Manhattan Beach, CA, 90266, US

(73) Assignee: OSRAM GESELLSCHAFT MIT BESCHRAENKTER HAFTUNG, Muenchen (DE)

(21) Appl. No.: 12/532,158

(22) PCT Filed: Apr. 23, 2007
(86) PCT No.: PCT/EP07/53937

§ 371 Date: Sep. 20, 2009

(51) Int. Cl. H05B 41/36

(52) U.S. Cl. 315/219

(57) ABSTRACT

A circuit arrangement for operating a low-pressure gas discharge lamp with a first and a second filament, between which a gas discharge can be formed, is provided. The circuit arrangement may include a device for generating an electrical potential which varies over time at a node, which is connected to the first filament via a first inductive element, and a half-circuit, which includes a switch, the first filament being electrically connected to the second filament when the switch of the half-circuit is closed, wherein a second inductive element is provided in the half-circuit.

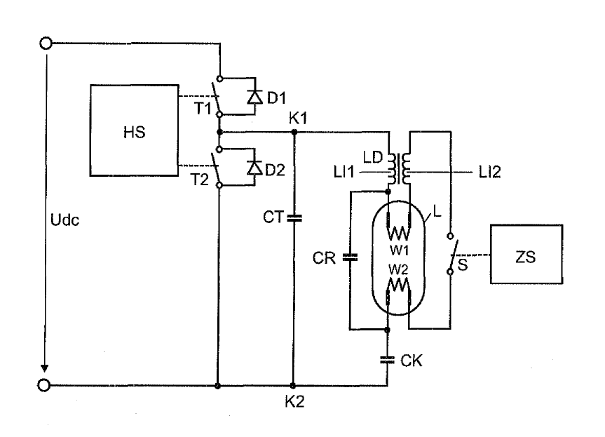

### TECHNICAL FIELD

The invention relates to a circuit arrangement for operating a low-pressure gas discharge lamp with a first and a second filament, between which a gas discharge can be formed, in particular to a circuit arrangement in accordance with the precharacterizing clause of claim 1.

### PRIOR ART

As is known, such a circuit arrangement includes a device for generating a potential which varies over time at a node (i.e. a voltage from the node to a reference point, for example to ground), the node being connected to the first filament via a first inductive element (inductance). The circuit arrangement furthermore includes a so-called heating circuit, namely a half-circuit which forms an electrical circuit with the rest of the circuit arrangement and includes a switch, to be precise the half-circuit serves the purpose of electrically connecting the first filament to the second filament, which is precisely the case when the switch is closed. The switch is closed, in particular by means of time control, when the low-pressure gas discharge lamp is switched on, to be precise prior to the starting of said lamp, in order that a heating current (produced as a result of the potential at the node) flows via the two filaments and preheats said filaments. The preheating facilitates the starting process which is then introduced. For starting purposes, the switch is opened, and the first inductive element interacts with a resonant capacitor, which is connected between the first filament and the second filament: as a result of resonance a particularly high voltage is generated, namely the starting voltage. The starting causes the gas discharge to be initiated, and during subsequent operation of the low-pressure gas discharge lamp, the operating voltage is then significantly lower than the starting voltage. During operation, the switch remains permanently open.

The half-circuit (i.e. the heating circuit) should itself have a resistance which is as low as possible in order that as much energy of the heating current as possible results in heating of the filaments. The heating circuit generally therefore includes in practice only the switch, one terminal of which is connected to the first filament via a connecting line and the other terminal of which is connected to the second filament via a connecting line.

At present it is virtually impossible for a designer to set the level of the heating current. Instead, the level of the heating current is determined by the remaining component parts of the circuit arrangement. Since the preheating is naturally of secondary importance with respect to the starting and the permanent operation of the low-pressure gas discharge lamp, the remaining component parts of the circuit arrangement are optimized in terms of starting and permanent operation, but not in terms of the preheating. The situation therefore often arises in the prior art that the heating current does not have the correct level. This is particularly disadvantageous if the heating current is too low and thus the preheating time is too long.

### DESCRIPTION OF THE INVENTION

The object of the present invention is to develop a circuit arrangement for operating a low-pressure gas discharge lamp in accordance with the precharacterizing clause of Patent claim 1 in such a way that there is the possibility of defining the level of the heating current.

This object is achieved in the case of a circuit arrangement having the features of the preamble of Patent claim 1 by the features of the characterizing clause of claim 1.

According to the invention, a second inductive element (inductance) is therefore provided in the half-circuit.

A designer wishing to use the prescribed switching principle who has to specifically select the components and in the process has to specifically select the properties of said components (capacitances of the capacitors, inductances of the inductive elements etc.) is provided with an additional degree of freedom by the second inductive element. By virtue of targeted selection of the inductance of the second inductive element, it is possible to establish in advance the level of the heating current and in particular ensure that the preheating time is not too long.

In a preferred embodiment, the second inductive element is magnetically coupled to the first inductive element, with the result that the effect of a transformer is achieved. As a result of the magnetic coupling, the circuit arrangement is stabilized in terms of its operation, and the said variables of the component parts can be set precisely in a sensitive manner.

In a preferred embodiment, the magnetic coupling is configured in such a way that the first and the second inductive element are each provided in the form of a coil on a coil former, to be precise on a coil former which is common to the two elements. Each coil is provided by in each case at least one winding. As is conventional with coils, a core (of soft-magnetic material) can be provided in the coil former, which core is therefore likewise common to the first and the second inductive element.

The second inductive element firstly makes it possible for the voltage present at the switch in the half-circuit to be influenced. In particular during starting, very high voltages of over 1000 volts are present between the two filaments of the low-pressure gas discharge lamp. In the prior art, the switch which is open during starting needs to withstand these voltages. Suitable switches are very expensive. An example of a switch which withstands a voltage of 1000 volts is a so-called 1200 V IGBT. It is now a preferred embodiment that the second inductive element is coupled to the first inductive element precisely in such a way that, when the switch is open, part of the voltage drop between the first and the second filaments drops across the second inductive element. In other words, the effect of the second inductive element is not intended to be such that the voltage present at the switch is increased in comparison with the situation without a second inductive element, but is reduced. Of the 1000 volts starting voltage, 500 volts can drop across the second inductive element, for example, with the result that in this case 500 volts are present across the switch. Switches which withstand an applied voltage of 500 volts are less expensive than switches which withstand an applied voltage of 1000 volts. Thus, for example, a 600 V MOSFET can be used, and this is less expensive than said 1200 V IGBT.

Irrespective of the setting of the heating current, the second inductive element has therefore proven to be of use in attempts to provide a less expensive design for the circuit arrangement.

### BRIEF DESCRIPTION OF THE DRAWING(S)

The invention will be explained in more detail below with reference to an exemplary embodiment. The FIGURE shows a circuit diagram of a circuit arrangement according to the invention.

### PREFERRED EMBODIMENT OF THE INVENTION

A low-pressure gas discharge lamp denoted by L in the FIGURE has a first filament W1 and a second filament W2. The low-pressure gas discharge lamp L can be operated on an AC voltage. The circuit arrangement generates this AC voltage from a DC voltage Udc by means of a device for generating a potential which varies over time, which device includes a half-bridge, namely two switches which are switched alternately on and off by a half-bridge controller HS. The switches are in the form of transistors T1 and T2 with diodes D1 and D2 connected in parallel (so-called freewheeling diodes). If the transistors T1 and T2 are switched perfectly alternately, a sequence of square-wave voltage pulses would be obtained without any further measures at the node K1, in a defined manner with respect to the second node K2 (i.e. a potential which varies over time at the node K1). By virtue of the provision of a so-called trapezoidal capacitor CT, a potential which varies over time with pulses in a form deviating from a square-wave form is actually achieved at the node K1. In particular, the edges are flattened in comparison with a perfect square-wave potential. The node K1 is not connected directly to the filament W1, but via a lamp inductor LD, i.e. in this case via a first inductive element LI1. The second filament W2 is connected to the node K2 via a coupling capacitor CK. The first inductive element LI1 and the coupling capacitor CK are designed precisely such that the operating current is optimized.

In order to achieve the operating state at all, the low-pressure gas discharge lamp L first needs to be started once.

In order that a relatively high starting voltage is provided, the effect of resonance is used. For this purpose, a resonant capacitor CR is provided which is connected in parallel with the path of the gas discharge, i.e. acts with a first terminal on the filament W1 and with a second terminal on the filament W2. Together with the first inductive element LI1, the resonant capacitor CR forms an LC resonant circuit, which has the effect of generating the starting voltage.

Prior to starting, it is now expedient to preheat the filaments W1 and W2 in order to safely initiate the starting. For this purpose, a heating circuit with a switch S is provided. If the switch S is closed, controlled by a time controller ZS, a current flows via all of the filaments W1 and W2 and heats said filaments. According to the invention, a second inductive element LI2 is now provided in the heating circuit. In this case, said second inductive element is formed in the same lamp inductor LD as the first inductive element LI1. The lamp inductor can include a coil former which surrounds a core, and the first inductive element LI1 can include a first number of windings, and the second inductive element LI2 can include a second number of windings connected as shown in the FIGURE. The inductive elements LI1 and LI2 are therefore directly magnetically coupled to one another, as is also the case for a transformer.

The second inductive element LI2 influences the level of the heating current, which represents a first aim of the invention.

A second aim of the invention consists in relieving the switch S of load at the time of starting. Without the second inductive element LI2, the entire starting voltage would be present across the terminals of the switch S, and a switch S would need to be provided which withstands the total starting voltage. Given a suitable winding direction of the windings of the first and second inductive element LI1 and LI2 with respect to one another, there is a voltage drop across the second inductive element LI2 which is precisely a voltage of such a polarity that the voltage across the switch S is reduced in comparison with the state without the second inductive element LI2. Thus, the switch S no longer needs to withstand the total starting voltage and can have a less expensive design.

The device shown in the FIGURE for generating a potential which varies over time at node K1 is merely by way of example. Other embodiments are also conceivable. The essence of the invention is the provision of the second inductive element LI2 in the heating circuit, which second inductive element is preferably magnetically coupled to the first inductive element LI1.

1. A circuit arrangement for operating a low-pressure gas discharge lamp with a first and a second filament between which a gas discharge can be formed, the circuit arrangement comprising: a device for generating an electrical potential which varies over time at a node, which is connected to the first filament via a first inductive element, and a half-circuit, which comprises a switch, the first filament being electrically connected to the second filament when the switch of the half-circuit is closed,
wherein a second inductive element is provided in the half-circuit.

2. The circuit arrangement as claimed in claim 1,
wherein the second inductive element is magnetically coupled to the first inductive element.

3. The circuit arrangement as claimed in claim 2,
wherein the first and the second inductive element are provided by in each case at least one winding on a common coil former.

4. The circuit arrangement as claimed in claim 2,
wherein the second inductive element is coupled to the first inductive element in such a way that, when the switch is open, part of the voltage drop between the first and the second filaments drops across the second inductive element.
